(19) United States
(12) Patent Application Publication
(10) Pub. No.: US 2016/0272509 A1
(43) Pub. Date: Sep. 22, 2016

(54) HALOGEN OXYACID ADSORBENT, METHOD FOR MANUFACTURING THE SAME, AND METHOD FOR TREATING HALOGEN OXYACID-CONTAINING WATER

(71) Applicant: Kabushiki Kaisha Toshiba, Minato-ku (JP)

(72) Inventors: Tomohito IDE, Inagi (JP); Toshihiro IMADA, Kawasaki (JP)

(73) Assignee: Kabushiki Kaisha Toshiba, Minato-ku (JP)

(21) Appl. No.: 15/068,709

(22) Filed: Mar. 14, 2016

(30) Foreign Application Priority Data
Mar. 18, 2015 (JP) 2015-054343

(51) Int. Cl. C02F 1/28; B01J 41/02; B01J 41/10

(52) U.S. Cl. CPC C02F 1/281; B01J 41/10; B01J 41/02; C02F 1/288; C02F 2101/36

(57) ABSTRACT

A halogen oxyacid adsorbent of the present embodiment contains: a support material having a surface made of at least alumina; tetravalent cerium supported on the surface; and negative ions supported on the surface.

### CROSS-REFERENCE TO RELATED APPLICATION

This application is based upon and claims the benefit of priority from the prior Japanese Patent Application No. 2015-054343, filed on Mar. 18, 2015, the entire contents of which are incorporated herein by reference.

### FIELD

Embodiments described herein relate generally to a halogen oxyacid adsorbent, a method for manufacturing the same, and a method for treating halogen oxyacid-containing water.

### BACKGROUND

Bromine is present in a small amount in the form of negative ions in groundwater and river water or the like. However, the bromine may be oxidized to bromate ion that has a carcinogenic property according to an oxidation treatment such as an ozone treatment. Since the standard value of the bromate ions in tap water is as low as 10 ppb in Japan, the bromate ions are desirably removed by adsorption and reduction when the tap water is used as drinking water.

For example, Patent Document 1 discloses a reduction method using a composite hydroxide containing iron and aluminum. Since it is necessary to manufacture a composite oxide according to a hydrothermal reaction performed under high temperature and pressure, the composite oxide is not easily manufactured.

On the other hand, power generation using nuclear power which does not generate carbon dioxide without using fossil fuels is promising as measures against global warming. However, in an unexpected unforeseen situation, the fear of radioactive iodine emitted into the environment is pointed out. The radioactive iodine may be oxidized in the atmosphere or water, to form iodate ions. In this case, since the adsorption and recovery of the iodate ions can largely contribute to environmental protection, the appearance of an adsorbent capable of selectively adsorbing the iodate ions at high efficiency is expected.

### BRIEF DESCRIPTION OF THE DRAWINGS

FIG. 1 is a conceptual diagram of a water treating system using a halogen oxyacid adsorbent of an embodiment; and

FIG. 2 is a sectional schematic view of a water treating tank as a substantial part of the water treating system of the embodiment.

### DETAILED DESCRIPTION

Hereinafter, the embodiment for carrying out the present invention will be described with reference to the drawings.

### (Halogen Oxyacid Adsorbent)

A halogen adsorbent of an embodiment contains at least a support material having a surface made of at least alumina; and cerium and negative ions supported on the support material. The support material having a surface made of at least alumina may be a pure alumina support or a silica alumina support having a high alumina ratio. The support material may have a composite structure including a substrate made of zeolite, a silica gel, silica alumina, titania, zirconia, or an aluminium alloy, and alumina with which the surface of the substrate is thinly covered. This is because, in the composite structure, the alumina with which the surface is covered is suitable for firmly supporting the cerium and the negative ions.

The negative ions are preferably selected from nitrate ions and chloride ions. The nitrate ions and the chloride ions may be used alone, or simultaneously used. This is because these have approximate properties to provide the same function effect.

Regarding the size of the support material in the present embodiment, it is preferable that the average primary particle size is 100 μm or more and 5 mm or less. When the support material has an average primary particle size of 100 μm or more and 5 mm or less, for example, it is possible to realize both a high filling rate of a halogen oxyacid adsorbent in a column, a cartridge or a tank and easiness of water flow, when performing adsorption of halogen oxyacid. When the average primary particle size is less than 100 μm, the filling rate of the halogen oxyacid adsorbent in the column or the like becomes too high to reduce the void ratio, which may make it difficult to make water flow.

On the other hand, when the average primary particle size exceeds 5 mm, the filling rate of the halogen oxyacid adsorbent in the column or the like is too low to increase the void, thus it becomes easy to make water flow. However, the contact area between the halogen oxyacid adsorbent and waste water containing halogen oxyacid is reduced, thus the percentage of adsorption of halogen oxyacid achieved by the halogen oxyacid adsorbent may be reduced.

The average primary particle size of the support material is preferably 100 μm or more and 2 mm or less, and more preferably 100 μm or more and 300 μm or less, or 300 μm or more and 1 mm or less. When the average primary particle size is 100 μm or more and 300 μm or less, the specific surface area of the halogen oxyacid adsorbent can be increased, which is preferable. When the average primary particle size is 300 μm or more and 1 mm or less, a pressure loss caused by water flow is decreased, which is preferable.

The average primary particle size can be measured by a sieving method. Specifically, in accordance with JIS Z8901: 2006 “Test powders and test particles”, it is possible to measure the average primary particle size by performing sieving using a plurality of sieves each having an void between 100 μm and 5 mm.

Acid-base properties such as the acidity, neutrality, and basicity of the alumina, and crystal forms such as the alpha, beta, and gamma types of the alumina are not particularly limited, but alumina having a larger specific surface area can increase the supported amount of cerium, which is preferable.

In the halogen oxyacid adsorbent of the present embodiment, the size of the adsorbent itself can be adjusted only by changing the size of the support material, and it can be understood that, for obtaining an adsorbent which is easy to handle, the size of the support material should be set to a predetermined size. More specifically, it is possible to immediately obtain a granular adsorbent without performing operation such as granulation, and to obtain a halogen oxyacid adsorbent which is easy to handle. As described above, since it is not necessary to perform granulation or the like, it is possible to simplify a manufacturing process required for obtaining the halogen oxyacid adsorbent which is easy to handle, resulting in that the reduction in cost can be realized.

The cerium of the embodiment is supported on the support material by impregnating the support material with a solution containing trivalent cerium (hereinafter, described as (III)) ions, and oxidization using an oxidizer. Counter ions of the cerium (III) ions, and negative ions derived from the oxidizer are also simultaneously supported on the support material.

A compound containing cerium (III) is preferably a water-soluble cerium salt such as cerium nitrate (III), cerium sulfate (III), or cerium chloride (III). The negative ions contained in these salts are contained in the adsorbent. Other rare earth metal compounds such as praseodymium and terbium, and non-rare earth metal compounds such as aluminum, zirconium, and titanium salts may be used together with the cerium compound. A double salt containing the metals and cerium may be used. This is because these compounds are satisfactorily supported together with cerium (III) to contribute to adsorption.

The negative ions can be substituted by ion exchange, because these ions forms ionic bond in adsorbent. For example, the halogen oxyacid adsorbent manufactured using the cerium nitrate (III) is immersed with a NaCl solution having a suitable concentration to substitute the nitrate ions by the chloride ions.

Hydrogen peroxide, hydrogen persulfate sodium, hydrogen persulfate potassium, hydrogen persulfate ammonium, and tert-butyl peroxide or the like can be used as the oxidizer. The hydrogen peroxide provides only water as a side product, which is preferable. The hydrogen peroxide can be used in a state where it is diluted with water as necessary. Aqueous solution of hydrogen peroxide diluted with water is preferably used from safety.

Tetravalent cerium (hereinafter, described as (IV)) forming the halogen oxyacid adsorbent in the embodiment is considered to adsorb halogen oxyacid ions in waste water. More specifically, halogen oxyacid is present in the form of anions in the waste water. Such anions are considered to interact with the cerium (IV) in the halogen oxyacid adsorbent, thereby achieving halogen oxyacid adsorption in the waste water. After the adsorption of the halogen oxyacid, the desorption of the negative ions constituting the adsorbent at the number of moles comparable with that of the adsorbed halogen oxyacid is observed by ion chromatography. Therefore, the ion exchange is presumed to be a main adsorption mechanism.

Since the adsorption is mainly provided by the ion exchange, it is found that a compound mainly contributing to the adsorption among compounds formed on the surface of the support material is not cerium oxide (CeO₂). At present, the compound formed on the surface of the support material is unclear. However, since the negative ions contained in the cerium (III) salt are emitted by the ion exchange, a cerium (IV) compound is presumed to be produced, which contains hydroxide ions and the negative ions contained in the cerium (III) salt such as CeO(X)₂, Ce₂OX₃, Ce(OH)ₙX₄₋ₙ, CeO(OH)ₙX₂₋ₙ, Ce₂O(OH)ₙX₆₋ₙ, and Ce₂O₂(OH)ₙX₄₋ₙ (X is a nitrate ion or a chloride ion). Cerium (III) may be partially contained.

### (Method for Manufacturing Halogen Oxyacid Adsorbent)

Next, a method for manufacturing the halogen oxyacid adsorbent of the present embodiment will be described. A manufacturing method to be described below is an example, and is not particularly limited as long as the halogen oxyacid adsorbent of the present embodiment can be obtained. The method for manufacturing the halogen oxyacid adsorbent of the embodiment includes the steps of bringing cerium (III) ions into contact with an alumina support, and oxidizing the cerium (III) ions to cerium (IV) ions, for example.

First, an alumina support is prepared. The alumina support is immersed with an aqueous solution containing cerium (III) ions. Air bubbles may adhere to the support material. The air bubbles are removed by stirring and/or ultrasonic irradiation. The immersion may be performed at room temperature. The immersion can be performed during appropriate heating.

After the alumina support is immersed for a sufficient time, aqueous solution of hydrogen peroxide is added to the alumina support to oxidize cerium (III) to cerium (IV). The aqueous solution of hydrogen peroxide as the oxidizer preferably has a concentration which is about 30% of that of commercially available aqueous solution of hydrogen peroxide from the viewpoint of safety and reactivity. The reaction may be performed at room temperature, and the oxidization can be accelerated by heating. Since water boils rapidly at 100° C. or more, which concentrates hydrogen peroxide to cause explosion, the reaction is preferably performed at 90° C. or less in consideration of safety.

When negative ions contained in a cerium compound formed on the surface of the alumina support are substituted by ion exchange, for example, a halogen oxyacid adsorbent manufactured using cerium nitrate (III) is immersed with a NaCl solution having a suitable concentration, and thereby nitrate ions can be substituted by chloride ions.

### (Halogen Oxyacid Adsorption System and Method for Using Halogen Oxyacid Adsorbent)

Next, an adsorption system using the aforementioned halogen oxyacid adsorbent and a method for using the same, i.e., a method for treating target water containing halogen oxyacid will be described. A halogen oxyacid adsorption system includes an adsorbing unit having a halogen oxyacid adsorbent, a supplying unit supplying a target medium containing a halogen oxyacid compound to the adsorbing unit, a discharging unit discharging the target medium from the adsorbing unit, a measuring unit measuring a content of the halogen oxyacid compound in the target medium provided on at least one of the supplying unit side or discharging unit side of the adsorbing unit, and a controlling unit reducing the supplying amount of the target medium from the supplying unit to the adsorbing unit when a value calculated based on information from the measuring unit reaches a previously set value.

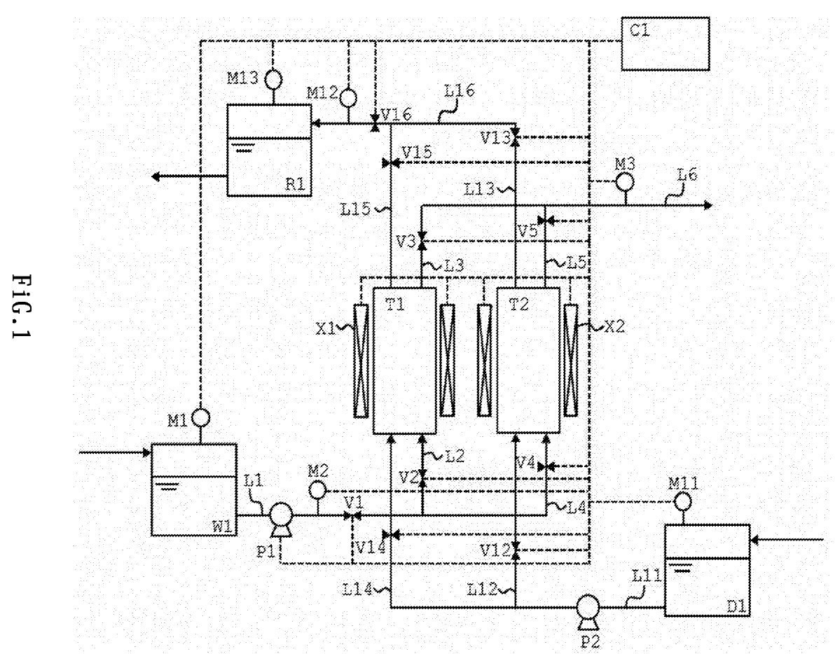

FIG. 1 is a conceptual diagram illustrating a schematic configuration of a water treatment apparatus used for adsorption of halogen oxyacid and a water treating system in the present embodiment.

As illustrated in FIG. 1, in the present apparatus, tanks for water treatment T1 and T2 filled with the aforementioned halogen oxyacid adsorbent are disposed in parallel, and on lateral sides of the tanks for water treatment T1 and T2, contact efficiency accelerators X1 and X2 are provided. The contact efficiency accelerators X1 and X2 can be provided as mechanical stirrers or non-contact magnetic stirrers; however, they are not essential components and thus can also be omitted.

To the tanks for water treatment (adsorbing unit) T1 and T2, a waste water storage tank W1 in which waste water (target water) containing a halogen oxyacid compound (iodide ions) is stored, is connected via waste water supply lines (supplying unit) L1, L2 and L4, and the tanks are connected to the outside via waste water discharge lines (discharging unit) L3, L5 and L6.

In the supply lines L1, L2, and L4, there are provided valves (controlling unit) V1, V2, and V4, respectively, and in the discharge lines L3 and L5, there are provided valves V3 and V5, respectively. In the supply line L1, a pump P1 is provided. Furthermore, in the waste water storage tank W1, the supply line L1 and the discharge line L6, concentration measuring units (measuring unit) M1, M2 and M3 are respectively provided.

The control of the aforementioned valves and pump, and the monitoring of measured values in the measuring apparatuses are collectively and centrally controlled by a controller C1.

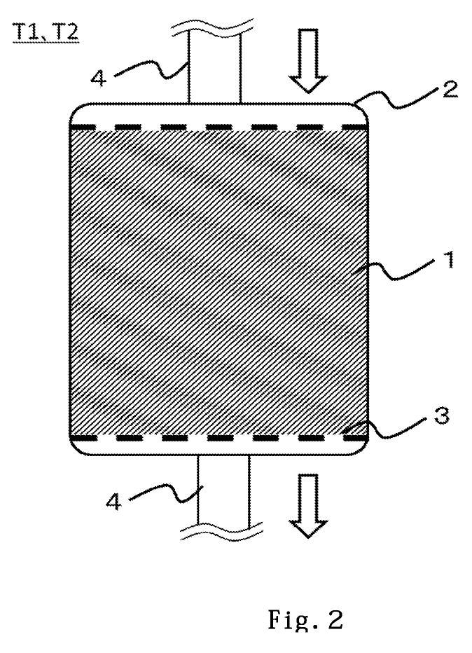

FIG. 2 illustrates a conceptual cross sectional view of tanks for water treatment T1 and T2 filled with the halogen oxyacid adsorbent connected to pipings 4 (L2 to L4). Arrows in the figure illustrate the flow direction of target water. The tanks for water treatment T1 and T2 include a halogen oxyacid adsorbent 1, a tank 2 accommodating the halogen oxyacid adsorbent, and a partition board 3 so as not to allow the halogen oxyacid adsorbent to leak outside the tank 2. The tanks for water treatment T1 and T2 may be a cartridge form in which the tank 2 itself is exchangeable or may be a form in which the halogen oxyacid adsorbent in the tank 2 is exchangeable. When there is anything to be adsorbed and collected other than halogen, other adsorbent can be accommodated in the tank 2.

Next, the adsorption operation of halogen using the apparatus illustrated in FIG. 1 will be described.

First, waste water is supplied from the tank W1 to the tanks for water treatment T1 and T2 through the waste water supply lines L1, L2 and L4 using the pump P1. At this time, halogen in the waste water is adsorbed in the tanks for water treatment T1 and T2, and the waste water after the adsorption is performed is discharged to the outside through the waste water discharge lines L3 and L5.

At this time, it is possible to enhance the adsorption efficiency of halogen provided by the tanks for water treatment T1 and T2, by driving the contact efficiency accelerators X1 and X2 as necessary, to increase the contact area between the halogen oxyacid adsorbent filled in the tanks for water treatment T1 and T2 and the waste water.

Here, adsorption states of the tanks for water treatment T1 and T2 are observed by the concentration measuring unit M2 provided on the supply side and the concentration measuring unit M3 provided on the discharge side, respectively, of the tanks for water treatment T1 and T2. When the adsorption proceeds smoothly, the concentration of halogen measured by the concentration measuring unit M3 indicates a value lower than that of the concentration of halogen measured by the concentration measuring unit M2. However, as the adsorption of halogen in the tanks for water treatment T1 and T2 gradually proceeds, a difference in the concentrations of halogen in the concentration measuring units M2 and M3 disposed on the supply side and the discharge side is decreased.

Therefore, when the value measured by the concentration measuring unit M3 reaches a previously set predetermined value, and it is judged that the adsorption ability of halogen by the tanks for water treatment T1 and T2 reaches saturation, the controller C1 once stops the pump P1, closes the valves V2, V3 and V4, and stops the supply of waste water to the tanks for water treatment T1 and T2, based on the information from the concentration measuring units M2 and M3.

While it is virtually difficult to treat raw water for tap water, tap water, water for agricultural use, and water for industrial use, or the like after the pH adjustment, it is also possible to treat these kinds of water without any pH adjustment. After the adsorption ability of halogen of the tanks for water treatment T1 and T2 reaches saturation, the tanks are appropriately changed with new tanks for water treatment filled with the halogen oxyacid adsorbent, and the tanks for water treatment T1 and T2 in which the adsorption of halogen oxyacid reaches saturation are appropriately subjected to necessary post-treatment. For example, when the tanks for water treatment T1 and T2 contain radiohalogen oxyacid, the tanks for water treatment T1 and T2 are broken into pieces, and then subjected to cement solidification and stored as radioactive waste in an underground facility or the like.

Here, in order to allow the target water to be continuously treated, a holding tank D1 for the halogen oxyacid adsorbent is separately set. The halogen oxyacid adsorbent can be supplied to the tanks T1 and T2 using a pump P2 through supply lines L11, L12, and L14 from the tank D1. The adsorbent can be sent and moved in a fluid state where the adsorbent is dipped in water. After the adsorbent adsorbs the halogen oxyacid, the adsorbent is temporarily stored in a storage tank R1 through discharge lines L13, L15, and L16, and thereby the treatment of the target water can be continuously advanced without stopping a treating apparatus. Here, a measuring apparatus M11 measures the amount of the halogen oxyacid adsorbent in the tank D1. An apparatus M12 measures the discharge amount of the adsorbent. An apparatus M13 measures the amount of the adsorbent in the storage tank R1. Control valves V12, V13, V14, V15, and V16 control the moving amount of the adsorbent moving in lines connected according to the control signal of the controller C1.

### Example 1

Cerium nitrate (III) (0.6 g) and ion-exchange water (3 mL) were placed in an eggplant flask (100 mL) including a magnetic stir bar, and the mixture was stirred to form a homogeneous solution. Preliminarily prepared alumina particles (particle diameter: 150 to 500 μm, 0.3 g) were added thereto, and the mixture was stirred at 20° C. for 5 minutes. Subsequently, 35% aqueous solution of hydrogen peroxide (3 mL) was added thereto, and the mixture was stirred at 20° C. for 30 minutes. Then, an appropriate amount of ion-exchange water was added thereto, to disperse a fine cerium (IV) compound which was not supported on alumina. After only the alumina precipitated, a supernatant was removed by decantation (repeating 3 times). The alumina was moved to KIRIYAMA funnel, and sufficiently washed with ion-exchange water. Then, drying was performed under reduced pressure to obtain an adsorbent of Example 1 as orange particles (yield: 3.3 g). The adsorbent was used as a halogen oxyacid adsorbent 1 described in FIG. 1.

### Example 2

A manufacturing process was performed in a state where 20° C. in Example 1 was changed into 30° C., to obtain an adsorbent of Example 2. In addition, explanations about the same manufacturing process and processing process as those of Example 1 were omitted. The explanations of the following Examples and Comparative Examples are also the same.

### Example 3

A manufacturing process was performed in a state where 20° C. in Example 1 was changed into 50° C., to obtain an adsorbent of Example 3.

### Example 4

A manufacturing process was performed in a state where 20° C. in Example 1 was changed into 60° C., to obtain an adsorbent of Example 4.

### Example 5

A manufacturing process was performed in a state where 20° C. in Example 1 was changed into 70° C., to obtain an adsorbent of Example 5.

### Example 6

A manufacturing process was performed in a state where 20° C. in Example 1 was changed into 80° C., to obtain an adsorbent of Example 6.

### Example 7

A manufacturing process was performed in a state where 20° C. in Example 1 was changed into 90° C., to obtain an adsorbent of Example 7.

### Example 8

The adsorbent of Example 7 (500 mg) was added to a glass screw vial (20 mL), and 5 mL of a 10 wt % NaCl solution was added thereto. The mixture was stirred at room temperature in a mix rotor (100 rpm) for 1 hour. Subsequently, the adsorbent was collected by suction filtration. The collected adsorbent was sufficiently washed with ion-exchange water. Then, the adsorbent was dried under reduced pressure to obtain an adsorbent of Example 8 (yield: 478 mg).

### Comparative Example 1

The alumina support of Example 1 was untreated without performing the manufacturing process, to obtain an adsorbent of Comparative Example 1.

### Comparative Example 2

A commercially available cerium hydroxide-based adsorbent (READ B manufactured by Nihonkaisui Co., Ltd.) was air-dried at room temperature overnight, to obtain an adsorbent of Comparative Example 2.

### Comparative Example 3

An experimental trial was performed in a state where the alumina particles of Example 1 were changed into silica gel particles (particle diameter: 63 to 210 μm), to obtain an adsorbent of Comparative Example 3.

### Comparative Example 4

An experimental trial was performed in a state where the alumina particles of Example 1 were changed into zeolite particles (faujasite, particle diameter: 500 to 1180 μm), to obtain an adsorbent of Comparative Example 4.

### (Halogen Oxyacid Adsorption Test)

A halogen oxyacid adsorbent (0.010 g) was placed in a wide-mouth vial made of polyethylene (50 mL), and a 0.3 mmol/L sodium iodide aqueous solution or a potassium bromate aqueous solution (50 mL) was added thereto. After the vial was closed with a lid, the vial was stirred by a shaker (60 μm, 25° C.) for 24 hours. Promptly after the completion of stirring, filtration was carried out through a cellulose membrane filter of 0.45 μm.

The halogen oxyacid concentration was quantified by ion chromatography. Alliance 2695 manufactured by Waters K.K. was used for an ion chromatograph system, and Shodex IC SI-90 4E and a 1.8 mM sodium carbonate-1.7 mM sodium hydrogen carbonate aqueous solution were used respectively for a column and an eluent. The amount of the adsorbed halogen oxyacid was calculated by taking a difference between the concentration of the halogen oxyacid contained in the target water used and the concentration of the residual halogen oxyacid ions in the target water subjected to the adsorption test, and the amount of halogen oxyacid adsorption was obtained from the amount of the adsorbent used.

### (Halogen Oxyacid Adsorbent Compressive Test)

The adsorbent was subjected to compressive test using an autograph apparatus. Compressive strength St (MPa) was calculated based on the formula (1) described in Non-Patent Literature 1 based on the load of a rupture point.

$$\begin{matrix}[ Mathematical Formula 1 ] & \\ St = 1.4 \frac{{F}_{o}}{2 π {a}^{2}} & ( 1 )\end{matrix}$$

In the formula, F₀ is load (N), π is a circular constant, and a is a particle radius (mm). When the support material was a resin or the like, and plastic-deformed before being fractured, the compressive strength St was similarly calculated from the formula (1) based on the load at the ending point of elastic deformation. Seven particles were tested. Five data except the minimum value and the maximum value among the particles were subjected to Q test (confidence limit: 90%), and average compressive strength was obtained from the data which were not rejected. Micro Autograph MST-I manufactured by Shimadzu Corporation was used as the autograph apparatus, and a stroke speed was set to 0.5 mm/min.

As described above, the results of subjecting the halogen oxyacid adsorbents obtained in Examples 1 to 7 and Comparative Examples 1 and 2 to the aforementioned test using the potassium bromate aqueous solution are shown in Table 1.

TABLE 1

| | Reaction | Adsorption amount |
|---|---|---|
| Sample | temperature [° C.] | [mg-BrO₃/g] |
| Example 1 | 20 | 14 |
| Example 2 | 30 | 15 |
| Example 3 | 50 | 13 |
| Example 4 | 60 | 14 |
| Example 5 | 70 | 16 |
| Example 6 | 80 | 16 |
| Example 7 | 90 | 19 |
| Example 8 | 90 | 21 |
| Comparative | 20 | 2.6 |
| Example 1 | | |
| Comparative | 20 | 8.4 |
| Example 2 | | |

The results of subjecting the halogen oxyacid adsorbents obtained in Examples 1 to 7 and Comparative Examples 1 to 4 to the aforementioned test using the sodium iodate aqueous solution are shown in Table 2.

TABLE 2

| | Reaction | Adsorption |
|---|---|---|
| Sample | temperature [° C.] | amount [mg-IO₃/g] |
| Example 1 | 20 | 51 |
| Example 2 | 30 | 54 |
| Example 3 | 50 | 55 |
| Example 4 | 60 | 61 |
| Example 5 | 70 | 63 |
| Example 6 | 80 | 65 |
| Example 7 | 90 | 64 |
| Example 8 | 90 | 22 |
| Comparative | 20 | 18 |
| Example 1 | | |
| Comparative | 20 | 21 |
| Example 2 | | |
| Comparative | 20 | 3.4 |
| Example 3 | | |
| Comparative | 20 | 0 |
| Example 4 | | |

The results of subjecting the halogen oxyacid adsorbents obtained in Examples 1 to 7 and Comparative Examples 1 and 2 to the compressive test are shown in Table 3.

TABLE 3

| | | Average |
|---|---|---|
| | Reaction | compressive |
| Sample | temperature [° C.] | strength [MPa] |
| Example 1 | 20 | 14.7 |
| Example 2 | 30 | 21.3 |
| Example 3 | 50 | 14.3 |
| Example 4 | 60 | 17.4 |
| Example 5 | 70 | 19.0 |
| Example 6 | 80 | 20.8 |
| Example 7 | 90 | 24.0 |
| Comparative | 20 | 10.6 |
| Example 1 | | |
| Comparative | 20 | 4.6 |
| Example 2 | | |

The results of Table 1 showed that the adsorbents of Examples 1 to 7 (reaction temperature: 20° C. to 90° C.) had a higher bromate adsorption amount than those of Comparative Examples 1 and 2. When the reaction temperature exceeded 70° C., the adsorption amount was slightly increased, and the adsorbent synthesized at 90° C. had a higher adsorption amount than those of other Examples. This is presumed to be because the content of cerium (IV) is increased by a higher temperature treatment. Example 8 which was treated with the NaCl solution to be substituted by chloride ions had a higher adsorption amount than that of Example 7 having nitrate ions.

Also in the adsorption of iodic acid (Table 2), it was found that the adsorbents of Examples 1 to 7 had a higher adsorption amount than those of Comparative Examples 1 and 2. When the reaction temperature exceeds 60° C., the adsorption amount is slightly increased. This is presumed to be an effect provided by a high temperature treatment as in the case of the adsorption of bromic acid. Example 8 treated with the NaCl solution also had a slightly higher adsorption amount than those of Comparative Examples 1 and 2. It is found that Comparative Examples 3 and 4 using a silica gel and zeolite as the support material other than alumina have a small adsorption amount, and alumina is a suitable support material. The adsorption amounts of iodic acid and discharge amounts of nitric acid of the adsorbents of Examples 1 to 7 are shown in Table 4. The substance amount of the adsorbed iodic acid is almost the same as that of the discharged nitric acid. This is presumed to be mainly provided by an ion exchange type adsorption mechanism.

TABLE 4

| | adsorption amount | discharge amount |
|---|---|---|
| | of iodic acid | of nitric acid |
| Sample | [μmol/g] | [μmol/g] |
| Example 1 | 293 | 251 |
| Example 2 | 307 | 309 |
| Example 3 | 312 | 355 |
| Example 4 | 347 | 380 |
| Example 5 | 363 | 378 |
| Example 6 | 374 | 385 |
| Example 7 | 366 | 370 |

The results (Table 3) of the compressive test showed that Examples 1 to 7 had larger compressive strength than those of Comparative Examples 1 and 2. Particularly, Examples 1 to 7 had compressive strength by 3 times or more than that of Comparative Example 2. When an adsorption tank is filled with an adsorbent, a large load may be applied to the lower part of the adsorbent to cause the breaking of the adsorbent. For this reason, it is found that the amounts of the adsorbents of Examples 1 to 7 having high compressive strength, with which the adsorption tank can be filled are more than those of Comparative Examples 1 and 2. Examples 1 to 7 have higher compressive strength than that of Comparative Example 1 which is a substrate. The detailed cause is not clear at present, but for example, the cerium (IV) compound is presumed to deposit in particle holes, and serve as a binder.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

T1, T2: column for water treatment, P1: pump, M1, M2, M3: concentration measuring unit, C1: controller, W1: waste water storage tank, L1, L2, L4: waste water supply line, L3, L5, L6: waste water discharge line, V1, V2, V3, V4, V5: valve, X1, X2: contact efficiency accelerator, 1: halogen oxyacid adsorbent, 2: tank, 3: partition board, 4: piping

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A ternary halogen oxyacid adsorbent comprising:
a support material having a surface made of at least alumina;
tetravalent cerium supported on the surface; and
negative ions supported on the surface.

2. The ternary halogen oxyacid adsorbent according to claim 1, wherein the negative ions are at least one kind selected from nitrate ions and chloride ions.

3. A method for manufacturing a halogen oxyacid adsorbent, the method comprising the steps of:
immersing a support material having a surface made of at least alumina in an aqueous solution containing trivalent cerium ions to support the cerium ions; and
adding aqueous solution of hydrogen peroxide to the aqueous solution containing trivalent cerium ions to oxidize the cerium ions to tetravalent cerium ions.

4. A method for treating halogen oxyacid-containing water, the method comprising the steps of:
preparing a ternary halogen oxyacid adsorbent containing a support material made of at least alumina, and tetravalent cerium and negative ions supported on a surface of the support material; and
bringing target water containing halogen oxyacid ions into contact with the adsorbent, to remove the halogen oxyacid ions from the target water.

5. A method for treating halogen oxyacid-containing water, the method comprising the steps of:
preparing a ternary halogen oxyacid adsorbent containing a support material made of at least alumina, and tetravalent cerium and negative ions supported on a surface of the support material; and
bringing target water containing halogen oxyacid ions into contact with the adsorbent, to reduce a concentration of the halogen oxyacid ions in the target water.
